(19) United States
(12) Patent Application Publication
(10) Pub. No.: US 2026/0184026 A1
(43) Pub. Date: Jul. 2, 2026

(54) FIBRE PLACEMENT MACHINE AND METHOD

(71) Applicant: CORIOLIS GROUP, QUÉVEN (FR)

(72) Inventors: Sebastien BERLINGEN, LANESTER (FR); Alexander HAMLYN, PLOEMEUR (FR)

(21) Appl. No.: 19/129,949

(22) PCT Filed: Oct. 27, 2023
(86) PCT No.: PCT/FR2023/000165

§ 371 Date: May 14, 2025

(30) Foreign Application Priority Data
Nov. 15, 2022 (FR) FR2211845

(51) Int. Cl. B29C 70/38; B29C 70/54

(52) U.S. Cl. CPC B29C 70/384; B29C 70/54

(57) ABSTRACT

A fibre placement machine, includes a lay-up support capable of carrying or constituting a lay-up tool, a creel capable of storing and delivering a plurality of fibres, and a placement head including at least one compacting roller mounted so as to rotate about its longitudinal axis. The lay-up support is able to be driven in rotation about an axis of rotation and to be moved in translation along a first direction, perpendicular to the axis of rotation and to the longitudinal axis. The creel and the placement head are mounted on a support structure which is able to be moved in translation along a second direction, perpendicular to the first direction and to the axis of rotation, and parallel to the longitudinal axis.

The present invention relates to a fibre placement machine for the production of composite material parts, and to a corresponding method for the production of composite material parts.

Fibre placement machines are known for the production of composite material parts, comprising a lay-up support able to carry or constitute a lay-up tool, a creel able to store and deliver a plurality of fibres, and a fibre placement head comprising a compaction system including at least one compaction roller, for the application onto a lay-up surface of the lay-up tool of bands of one or more fibres coming from the creel, by relative displacement of the head with respect to the lay-up support via a displacement system. The fibres used may be pre-impregnated with a thermoplastic or thermosetting polymer, or dry fibres with a binder.

These fibre placement machines can be used to form substantially flat preforms, formed from a superposition of fibre plies in different orientations, each ply being formed from bands of fibres applied side by side with the placement head. In this case, the lay-up support typically comprises a table on which a lay-up tool can be arranged, such as a plate whose flat upper surface forms the lay-up surface. The table can also be formed by a plate constituting the lay-up tool. Flat preforms can be obtained at high production rates, and can be subjected to a forming operation to form three-dimensional preforms from which final three-dimensional parts are obtained.

In patent document U.S. Pat. No. 8,919,410, a fibre placement machine was proposed in which the placement head is mounted on a fixed creel, the table being able to be driven in rotation around a vertical rotation axis, and to be displaced in translation in two horizontal directions perpendicular to each other. During the lay-up by displacement of the table, the head and creel are fixed relative to each other, which simplifies the fibre path between creel and head, and enables high lay-up speeds to be achieved. This machine is suitable for producing small parts, e.g. less than 1 meter square. For large parts, the displacement system required to displace the table under the head in two horizontal directions takes up a substantial footprint. In view of the onboard weights, table speeds and accelerations in both directions can also be limited.

For the lay-up of larger preforms, the patent document U.S. Pat. No. 10,059,067 proposes a lay-up machine in which the table is mobile in rotation around a vertical axis, and mobile in translation along a first horizontal direction, the creel is arranged on the floor and the head is mounted on a gantry, mobile in translation in a second horizontal direction, this second direction being perpendicular to the first horizontal direction and perpendicular to the axis of rotation of the compaction roller. The lay-up of a first band on the table is carried out by displacing the head in the second horizontal direction. To lay-up a second band next to the first, the table is first displaced in the first direction to offset the table relative to the head, then the head is displaced in the second horizontal direction to apply the second band onto the table. During the lay-up of a fibre band, the head is displaced relative to the creel, which complicates the fibre path and limits lay-up accelerations and speeds.

The aim of the present invention is to propose a placement machine intended to overcome at least one of the aforementioned drawbacks.

To this end, the present invention proposes a fibre placement machine for the production of parts made of composite material comprising a lay-up support able to carry or constitute a lay-up tool, a creel able to store and deliver several fibres, and a fibre placement head comprising a compaction system including at least one compaction roller rotatably mounted around its longitudinal axis, for the application onto a lay-up surface of the lay-up tool of bands of one or more fibres coming from the creel, by relative displacement of the head with respect to the lay-up support, characterized in that, for said relative displacement,
said lay-up support is able to be driven in rotation around a rotation axis, preferably vertical, and to be displaced in translation along a first direction, preferably horizontal, perpendicular to the rotation axis and to the longitudinal axis of the compaction roller,
said machine comprises a support structure on which the creel and the placement head are mounted, said support structure being able to be displaced in translation along a second direction, perpendicular to the first direction and to the rotation axis, and parallel to the longitudinal axis of the compaction roller.

According to the invention, the lay-up support is mounted mobile in translation along a single first direction, perpendicular to the axis of the compaction roller, the head and creel being mounted mobile together in translation along a second direction perpendicular to the first direction and parallel to the axis of the compaction roller. The lay-up of a band can thus be carried out solely by displacement of the lay-up support, without displacement in translation of the head, the head being displaced in translation solely between the lay-up trajectories to offset the head and enable the lay-up of the bands next to one another. The creel and head remain fixed in relation to each other, and immobile during lay-up, enabling a simple fibre path between the head and creel, and the lay-up at high lay-up speeds with good lay-up quality.

The lay-up support mounted mobile in translation along a single axis also enables higher accelerations and lay-up speeds than a support mobile in translation along two perpendicular axes.

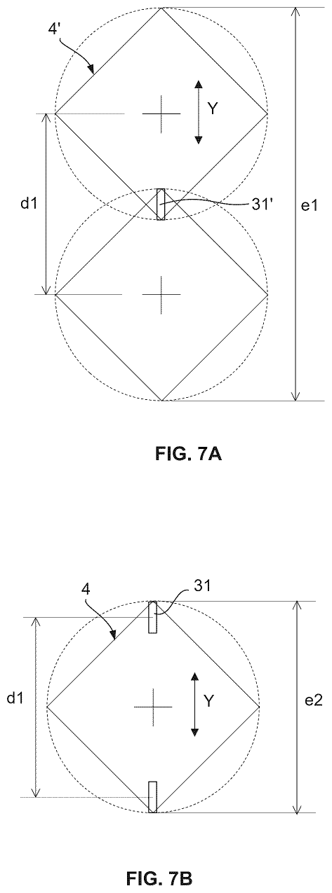

For a given lay-up surface, the displacement of the head and creel in the second direction, instead of the lay-up support, also makes it possible to greatly reduce the table footprint in the second direction, and thus to offer a smaller machine with a smaller footprint. By way of example, FIG. 7A illustrates, in the case of a machine of the prior art, the stroke d1 of the table 4′ in the second direction Y which is required to lay-up over the entire lay-up surface in all directions, and the corresponding footprint e1 of the table in the Y direction, the table being rotatable around a vertical axis and mobile in translation in the second direction Y, and the associated placement head being fixed in the second direction. The compaction roller of the head is shown schematically under reference 31′. FIG. 7B illustrates the stroke d1 of a placement head according to the invention, mobile in the second direction Y, with a compaction roller 31, combined with a table 4 of the same dimensions, rotatable around a vertical axis but fixed in the second direction, and the corresponding footprint e2 of the table in the second direction.

Similarly, the lay-up support mounted mobile in translation along a single axis makes it possible to have a lay-up surface at a reduced height, and therefore a lay-up head and creel at a reduced height, to which an operator can have easy access under good ergonomic conditions, without the need for an access platform.

In addition, by mounting the head and creel so that they can be moved together in translation along a second direction, it is possible to offset the head and the creel relative to the lay-up support to easily perform maintenance operations on the head and creel, without having to step over rails and without excessively increasing the machine's footprint.

The lay-up support can comprise a table on which lay-up tool can be arranged, such as a plate whose flat upper surface constitutes the lay-up surface. The table can also be formed by a plate constituting the lay-up tool.

The fibres usable by the machine are preferably flat unidirectional continuous fibres, classically known as tow, comprising a multitude of filaments. The fibres are typically less than or equal to half an inch in width, for example, widths of an eighth of an inch, a quarter of an inch or half an inch (⅛″ ¼″ or ½″). As used herein, the term “fibres” also refers to fibres with larger widths, greater than half an inch, classically referred to as tape in placement technology. The deposited fibres can be dry fibres with a binder, or fibres pre-impregnated with a thermosetting or thermoplastic polymer.

According to an embodiment, for its displacement in translation along the second direction, the support structure has an elongated shape extending parallel to the first direction, the support structure is mounted by a first end portion cantilevered on a carriage, said carriage being mounted mobile in translation on a linear rail preferably fixed to the floor, arranged along the second direction, the placement head being mounted on a second end portion of the support structure. This mounting of the support structure on a single rail, with the placement head cantilevered, makes it possible to offer a machine with a small footprint. In another embodiment, the support structure extends above the table and is mounted mobile in translation in the second direction on two rails arranged on either side of the table. This arrangement makes it possible to offer a machine with a lighter support structure, but with a larger footprint.

In an embodiment, for its displacement in translation along the first direction, the lay-up support is mounted mobile in rotation on a carriage around the rotation axis, said carriage being mounted mobile in translation on a linear rail, preferably fixed to the floor, arranged along the first direction.

In an embodiment, the placement head is mounted on the support structure so as to be mobile in translation in a third, preferably vertical, direction, perpendicular to the first and second directions. According to one embodiment, the placement head is connected to the support structure by at least one compaction cylinder, preferably pneumatic, and at least one position cylinder, preferably electric. In an embodiment, the placement head is mounted on the support structure so as to be mobile in translation along a single sliding plane, such mounting providing robust and precise guidance of the head in the third direction. According to an embodiment, the placement head is mounted on at least one first carriage which is slidably mounted on a rail fixed to the support structure, a position cylinder being connected by a first element among its body and rod to the support structure and being connected by the other element to a second carriage which is slidably mounted on said rail, a compaction cylinder being connected by a first element among its body and rod to said second carriage and by the other element to the first carriage. According to an embodiment, the fibre placement head is connected to the support structure by two compaction cylinders and a position cylinder, the head is mounted between two mounting plates, each mounting plate is connected to at least one first carriage, preferably two first carriages, slidably mounted on a rail integral with the support structure, a compaction cylinder is connected by its body to each mounting plate, and its rod is connected to a second carriage mounted on the rail, a position cylinder is mounted by its body on the support structure, and its rod is connected to a cross-member connecting the two second carriages, each second carriage preferably being mounted between two first carriages.

Another object of the present invention is a method for the production of composite material parts comprising the application of continuous, preferably unidirectional, fibres onto a lay-up surface, characterized in that said application is carried out by means of a fibre placement machine as previously defined. According to one embodiment, the part or preform obtained after the fibre application step is subjected to a forming, resin addition and/or curing operation to obtain a composite material part.

The invention will be better understood, and further aims, details, features and advantages will become clearer in the course of the following detailed explanatory description of a currently preferred particular embodiment of the invention, with reference to the appended schematic drawings, in which:

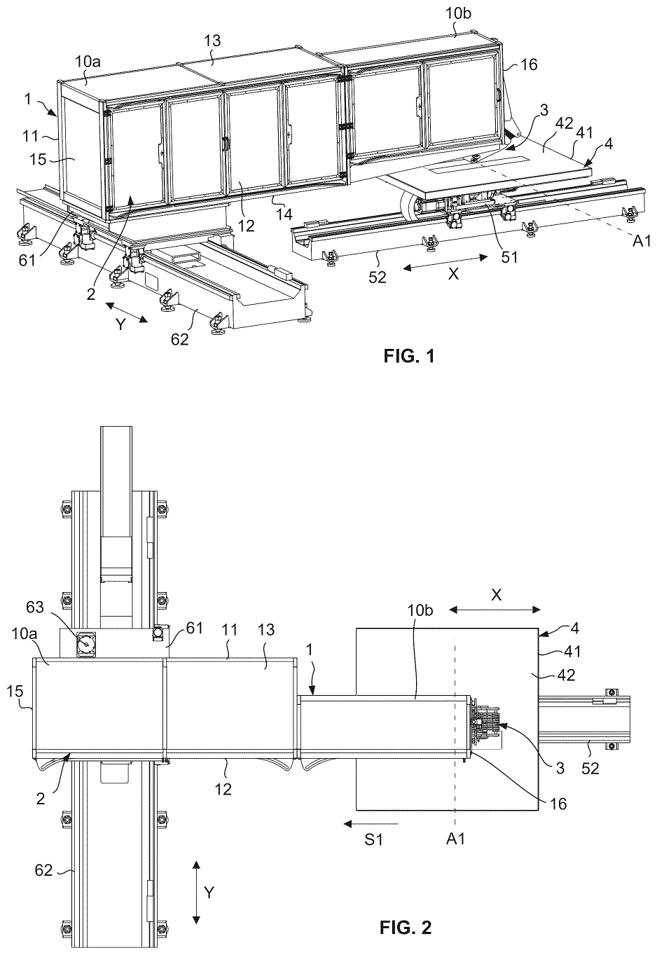

FIG. 1 is a perspective view of a placement machine according to the invention, the machine being in the process of lay-up a band of fibres onto the lay-up surface;

FIG. 2 is a top view of the machine shown in FIG. 1;

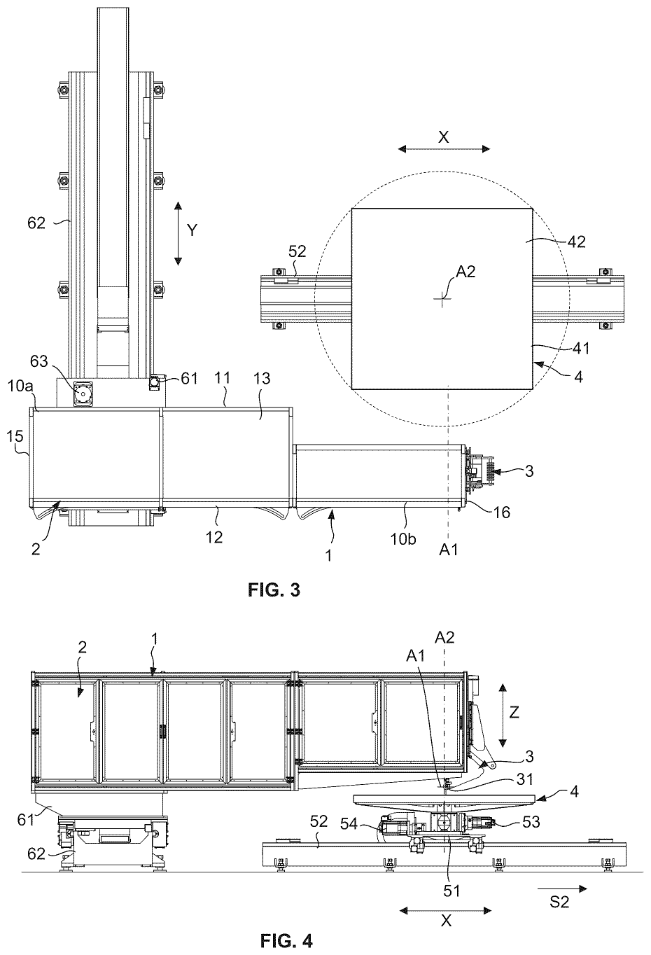

FIG. 3 is a top view similar to FIG. 2, with the support structure carrying the creel and the placement head in a maintenance position;

FIG. 4 is a side view of the placement machine, with the head in a high position above the table,

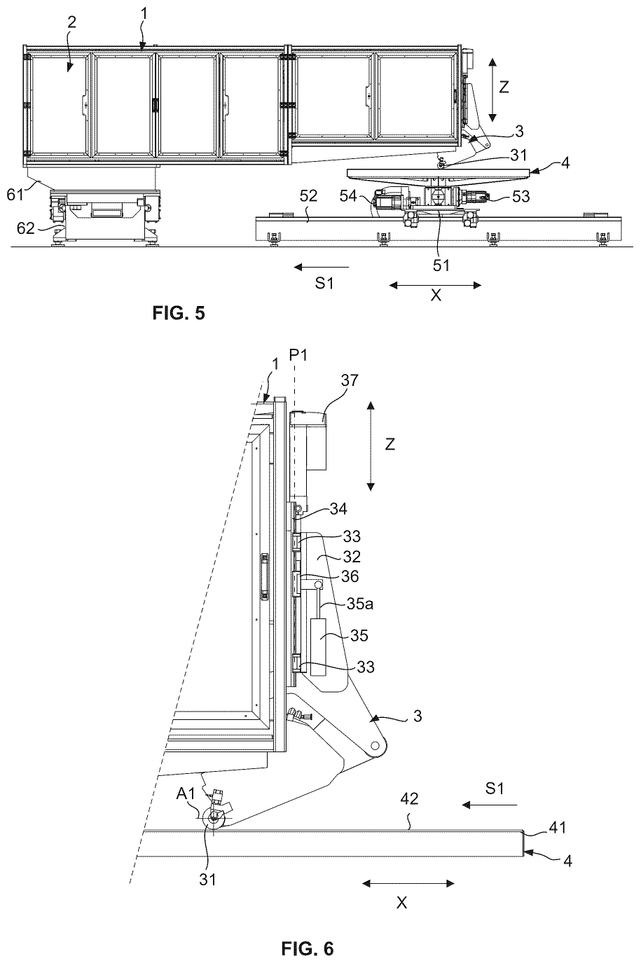

FIG. 5 is a side view similar to FIG. 4, with the head in a low position for the layup of a band on the table;

FIG. 6 is an enlarged partial view of FIG. 5 showing the head;

FIG. 7A is a diagram illustrating the stroke of a prior art table in the second Y direction and its corresponding footprint in this second direction for a given lay surface; and,

FIG. 7B is a diagram illustrating the stroke of the head according to the invention in the second direction Y and the corresponding footprint of the table in this second direction for the same lay-up surface.

With reference to FIGS. 1 to 5, the fibre placement machine comprises a support structure 1, on which is mounted a creel 2 for receiving fibre spools and a fibre placement head 3, and a lay-up support 4. The lay-up support 4 is mounted mobile in rotation around a vertical axis A2 and mobile in translation along a first horizontal direction X. The support structure carrying the creel and head is mounted mobile in translation along a second horizontal direction Y, perpendicular to the first direction X.

The lay-up support 4 comprises a table 41, formed by a rectangular plate. Here, the table constitutes the lay-up tool, its upper surface defining a flat lay-up surface 42. In another embodiment, the table is intended to receive a separate lay-up tool. The table is mounted rotatably around an axis A2 on a first carriage 51, the first carriage being mounted mobile in translation on a first linear rail 52 fixed to the floor in the first horizontal X direction. The table can be driven in rotation on the first carriage by a first motor 53, while the first carriage is able to be displaced in translation on the first rail by at least one second motor 54.

The support structure 1 is fixedly mounted on a second carriage 61 which is mobile in translation on a second rail 62 fixed to the floor in the second horizontal Y direction. The second carriage is able to be displaced in translation on the second rail by at least a third motor 63. The support structure has a generally parallelepiped shape, elongated in the first direction, with two opposite side faces 11, 12, an upper face 13, a lower face 14, a rear face 15, and a front face 16 arranged on the lay-up support side. The support structure comprises a first end portion 10a including the rear face 15, and a second end portion 10b including the front face 16. The head is mounted at the second end portion 10b of the support structure, for example at the front face 16. The support structure is mounted cantilevered on the second carriage 62 by its first end portion, and extends mostly on the side of the second rail where the first rail is positioned, so that the head is cantilevered above the floor and the table.

The machine is intended for the application of bands of continuous, flat, ribbon-like fibres, e.g. carbon fibres, packaged in spool form. The creel is formed in the support structure, mainly at the first end portion of the support structure, and comprises mandrels for receiving the fibre spools, which are accessible from a side face 12 of the support structure. By way of example, the machine is designed to apply bands of sixteen fibres, the creel comprising sixteen mandrels, which may be motorized, to receive sixteen fibre spools. In a manner known per se, the creel may comprise an oscillating roller, associated with each mandrel and over which the fibre passes, enabling the rotation of the mandrel to be controlled as a function of the position of the oscillating roller. Similarly, a secondary mandrel may be associated with each mandrel for rewinding any separator film as the fibre is unwound. Fibres unwound from the creel are guided to the head via pulley-type guiding systems.

In a manner known per se, the placement head 3 comprises:
an application roller or compaction roller 31 able to come into contact against the lay-up surface to apply a band of fibres;
a guiding system for guiding the fibres from the creel to the roller in the form of two bundles of fibres arranged in two guiding planes, so as to form a fibre band at the roller, in which the fibres are arranged substantially edge-to-edge;
a cutting system for individually cutting each fibre;
a rerouting system to reroute each fibre individually after it has been cut, so that the application of a fibre can be stopped and resumed at any time, and the width of the web can be selected; and,
a clamping system to clamp each newly cut fibre.

By way of example, the guiding system, and the cutting, rerouting and clamping systems are similar to those described in patent WO2008/132299.

The compaction roller is rotatably mounted around its longitudinal axis A1, the head being mounted on the support structure so that the longitudinal axis A1 of the roller is arranged parallel to the second horizontal Y direction. The head is mounted on the support structure so as to be mobile in translation in a third vertical Z direction. The head is connected to the support structure by at least one compaction cylinder, preferably pneumatic, the compaction cylinder defining the compaction force with which the fibres are applied to the mould by the compaction roller, and by at least one position cylinder, preferably electric, which defines the position of the head in the Z direction.

Referring to FIG. 6, the head is mounted so as to be mobile in translation along a vertical sliding plane P1 on two vertical rails 34 integral with the support structure. The head is mounted between two mounting plates 32, each equipped with two first carriages 33 slidably mounted on a vertical rail 34 integral with the support structure. A compaction cylinder 35 is mounted by its body on each mounting plate, and its rod 35a extends parallel to the Z direction and is connected to a second carriage 36 mounted on the rail associated with said mounting plate. The two second carriages are connected by a cross-member, and a position cylinder 37 is mounted by its body on the support structure and its rod is connected to said cross-member. The position cylinder 37 is used to maneuver the head between a high position illustrated in FIG. 4, in which the head is positioned above the table, and a low position illustrated in FIGS. 5 and 6, in which the head is able to come into contact against the table by its compaction roller. The compaction cylinders urge the head vertically downwards. The compaction cylinders, for example of the double-acting pneumatic type, are pressure-controlled to adapt the compaction force.

The machine can be used to produce preforms consisting of several superimposed plies in different orientations, each ply being formed by the lay-up bands of side by side fibres in a given orientation. The above-mentioned motors 53, 54, 63, as well as the position cylinder 37 and the compaction cylinders 35, are controlled by a machine control unit for the corresponding displacements of the head or table. The rotation of the table around the vertical axis A2 takes place before the realization of the first strip of a ply, in order to define the orientation of the ply. The displacement of the head in the Z direction is carried out only at the beginning and end of a band lay-up trajectory, the head being maneuvered in the low position to lay-up a band and in the high position to enable the table to be displaced in the X direction and the head to be displaced in the Y direction between two bands. For the lay-up of a first fibre band of a ply in a given orientation, the support structure with the head in the high position is displaced in the Y direction to bring the head above the table, the table having previously been positioned in rotation around the axis A2 according to the desired orientation of the ply. The head is maneuvered from its high position to its low position to bring the compaction roller against the table, and the table is displaced in the first direction X, in the first direction S1, towards the second rail 62. At the end of the deposit trajectory, the head is maneuvered into its high position. To lay-up a second band next to the first one, the support structure is displaced in direction Y to offset the head by one pitch relative to the first band, and the table is displaced in the second direction S2 (FIG. 4), opposite to the first direction, to reposition the head at the start of the first band. The head can then be moved to the lower position, and the table is displaced in direction S1 to apply the second band. In this way, a band is applied solely by displacing the table in the first direction X, while displacement of the head in the second direction Y is used only between two deposit trajectories.

Once the lay-up of a preform has been completed, the support structure can be displaced in the second direction Y at one end of the rail, into a maintenance position, as illustrated in FIG. 4. In this maintenance position, the support structure is moved away from the table, so that an operator can access, under good ergonomic conditions, the table to work on the preform and/or the table, as well as the head, for example, to carry out maintenance operations, or the creel to carry out maintenance operations, in particular to replace the spools.

In another embodiment, the low and high positions of the head are obtained by the compaction cylinders, each formed by a double-acting cylinder, the position cylinder being used solely to vary the low position of the head between two successive plies, as the thickness of the preform increases.

The machine according to the invention is advantageously used to produce flat preforms at high speeds, using trajectories without curvature in the fibre plane, i.e. without steering. Of course, the machine according to the invention can also be used to produce non-planar preforms and/or preforms with steering, by combining during deposit trajectories displacements of the table in the direction X, with displacements of the head in the direction Y or the direction Z, and/or rotational displacements of the table around its axis A2.

According to one embodiment, the machine comprises a tension-limiting system, for example as described in patent application FR21/14113 filed on Dec. 23, 2021 by the applicant, mounted on the support structure, between the creel and the head, in order to reduce the tension of the fibres entering the head.

According to one embodiment, the machine comprises a binder application system, for example as described in patent EP3426452, mounted on the support structure, between the creel and the head, or between the aforementioned tension-limiting system, if any, and the head, to apply a binder to each fibre coming from the creel.

Although the invention has been described in connection with a particular embodiment, it is clear that it is by no means limited thereto and that it includes all the technical equivalents of the means described, as well as combinations thereof, if these fall within the scope of the invention.

1. A fibre placement machine comprising:
a lay-up support able to carry or constitute a lay-up tool,
a creel able to store and deliver several fibres, and
a fibre placement head comprising a compaction system including at least one compaction roller rotatably mounted around its longitudinal axis for the application onto a lay-up surface of the lay-up tool of bands of one or more fibres coming from the creel, by relative displacement of the head with respect to the lay-up support,
wherein
said lay-up support is configured to be driven in rotation around a rotation axis and displaced in translation along a first direction perpendicular to the rotation axis and to the longitudinal axis of the compaction roller,
said machine comprises a support structure on which the creel and the placement head are mounted, said support structure being able to be displaced in translation along a second direction perpendicular to the first direction and to the rotation axis and parallel to the longitudinal axis of the compaction roller.

2. The fibre placement machine according to claim 1, wherein the support structure has an elongated shape extending parallely to the first direction, the support structure is mounted by a first end portion cantilevered on a carriage said carriage being mounted mobile in translation on a linear rail arranged along the second direction the placement head being mounted on a second end portion of the support structure.

3. The fibre placement machine according to claim 1, wherein the lay-up support is mounted mobile in rotation on a carriage around the rotation axis said carriage being mounted mobile in translation on a linear rail arranged along the first direction.

4. The fibre placement machine according to claim 1, wherein the placement head is mounted on the support structure so as to be mobile in translation in a third direction perpendicular to the first direction and to the second direction.

5. The fibre placement machine according to claim 4, wherein the placement head is connected to the support structure by at least one compaction cylinder and at least one position cylinder.

6. The fibre placement machine according to claim 5, wherein the placement head is mounted on the support structure so as to be mobile in translation along a single sliding plane.

7. The fibre placement machine according to claim 6, wherein the placement head is mounted on at least one first carriage which is slidably mounted on a rail fixed to the support structure a position cylinder being connected by a first element among its body and its rod to the support structure and being connected by the other element to a second carriage which is slidably mounted on said rail, a compacting cylinder being connected by a first element among its body and its rod to said second carriage and by the other element to the first carriage.

8. The fibre placement machine according to claim 1, further comprising a binder application system, mounted on the support structure between the creel and the head, for applying a binder to each fibre coming from the creel.

9. The fibre placement machine according to claim 8, wherein the binder application system is a fiberization system.

10. A method for the production of composite parts comprising applying continuous fibres to a lay-up surface, wherein said applying is performed by a fibre placement machine according to claim 1.

11. The method according to claim 10, wherein said applying is carried out by the fibre placement machine with a creel loaded with fibres pre-impregnated with a thermoplastic or thermosetting polymer, or with dry fibres provided with a binder.

12. The method according to claim 10, wherein said applying is carried out by the fibre placement machine that further comprises a binder application system, mounted on the support structure between the creel and the head, for applying a binder to each fibre coming from the creel, with in-line application of binder to each fibre exiting the creel.

13. The method according to claim 10, wherein said applying is carried out by the fibre placement machine that further comprises a fiberization system, mounted on the support structure between the creel and the head, for applying a binder to each fibre coming from the creel, with in-line application of binder to each fibre exiting the creel by the fiberization system.
